(19) United States
(12) Patent Application Publication
(10) Pub. No.: US 2006/0178126 A1
(43) Pub. Date: Aug. 10, 2006

(54) Diversity receiver system having a shared local oscillator source

(76) Inventors: Charles D. Thompson, Buda, TX (US); Andrew W. Dornbusch, Austin, TX (US); Saroj Rout, Nashua, NH (US)

Correspondence Address: TROP PRUNER & HU, PC, 1616 S. VOSS ROAD, SUITE 750, HOUSTON, TX, 77057-2631, US

(21) Appl. No.: 11/093,421

(22) Filed: Mar. 30, 2005

Related U.S. Application Data
(60) Provisional application No. 60/650,223, filed on Feb. 4, 2005.

(51) Int. Cl. H04B 1/28

(52) U.S. Cl. 455/333

(57) ABSTRACT

A technique includes fabricating receive paths of a diversity receiver on a monolithic semiconductor die. The technique includes fabricating a local oscillator source on the die to be shared in common with the receive paths of the diversity receiver.

This application claims the benefit of co-pending U.S. Provisional Application Ser. No. 60/650,223 entitled, “DIVERSITY RECEIVER WITH SHARED LOCAL OSCILLATOR SOURCE,” filed on Feb. 4, 2005, which is incorporated herein by reference in its entirety.

### BACKGROUND

The invention generally relates to a diversity receiver system that has a shared local oscillator source.

Subscriber-based satellite radio, every-increasing in popularity, may be installed in a variety of different mobile objects, such as watercraft, motor vehicles and airplanes. A typical equipment package for a mobile satellite radio system includes an antenna and a satellite radio receiver that are connected together by an antenna feedline. The antenna, in response to electromagnetic radiation that is received from one or more geosynchronous satellites and possibly one or more terrestrial repeaters, produces a radio frequency signal. The satellite radio receiver translates a selected RF channel of the radio frequency signal to baseband. From baseband, the signal may then be demodulated and converted into an analog signal that may be used to drive an audio speaker.

Because the satellite radio system typically is mobile, the system continually experiences different reception environments. These different reception environments, in turn, introduce different multipath and reflection effects that may affect the quality of the radio frequency signal that is received in the satellite radio receiver.

### SUMMARY

In an embodiment of the invention, a technique includes fabricating receive paths of a diversity receiver on a monolithic semiconductor die and fabricating a local oscillator source on the die to be shared in common with the receive paths.

In another embodiment of the invention, a system includes a monolithic semiconductor die and receive paths that are fabricated on the die. The system also includes a local oscillator source that is shared by the receive paths.

In yet another embodiment of the invention, a system includes a semiconductor die, a first receive path that is fabricated on the die and a second receive path that is fabricated on the die. The system includes a first quadrature generator that is fabricated on the die and is shared by the first and second receive paths. The system also includes a second quadrature generator that is fabricated on the die and is shared by the first and second receive paths.

Advantages and other features of the invention will become apparent from the following drawing, description and claims.

### BRIEF DESCRIPTION OF THE DRAWING

FIG. 1 is a flow diagram depicting a technique to share a local oscillator source in a diversity receiver system according to an embodiment of the invention.

FIGS. 2, 3 and 4 are schematic diagrams of diversity receiver systems according to different embodiments of the invention.

FIG. 5 is a schematic diagram depicting a receive path in accordance with an embodiment of the invention.

FIG. 6 is a schematic diagram of an image reject mixer according to an embodiment of the invention.

FIG. 7 is a schematic diagram of a mixer according to another embodiment of the invention.

FIG. 8 is a schematic diagram of a quadrature generator according to an embodiment of the invention.

FIG. 9 is a schematic diagram of a satellite radio receiver system according to an embodiment of the invention.

### DETAILED DESCRIPTION

In accordance with embodiments of the invention, a full diversity satellite radio system includes dual satellite radio receivers for purposes of overcoming multipath and reflection effects. More specifically, in some embodiments of the invention, each satellite radio receiver (having an identical design, in some embodiments of the invention) is connected to a different active antenna for purposes of receiving a radio frequency (RF) signal and translating the same RF channel to a baseband frequency. Due to their relative different orientations and positions, the antennas may experience different multipath and reflection effects. For example, one of the antennas may be mounted in a passenger side mirror housing of an automobile, and the other antenna may be mounted in the driver side mirror housing of the automobile. Thus, due to the orientation of the automobile, for example, the qualities of the RF signals that are processed by the receivers may differ significantly.

Therefore, in accordance with some embodiments of the invention, a carrier-to-noise (C/N) ratio is computed for the baseband signals that are produced by the receivers after the baseband signals are demodulated. Based on the C/N ratios, one of the satellite receivers (i.e., the satellite receiver that has a larger C/N ratio) is selected to process the incoming RF signal. It is noted that as the relative antenna orientations, antenna locations and other factors change, the selection may vary between the two satellite radio receivers.

In accordance with embodiments of the invention, the receive paths of the two satellite radio receivers are fabricated on the same monolithic semiconductor die of a semiconductor package.

In the context of this application, the “receive path” refers to all or part of the circuitry that translates a selected RF channel to another frequency. In the embodiments of the invention described below, each receive path includes circuitry to translate a selected RF channel to baseband. As described below, this circuitry may include, for example, one or more mixers and low noise amplifiers (LNAs), in some embodiments of the invention.

Although each receive path has conventionally had its own local oscillator sources, it has been discovered that due to the inclusion of both receive paths on the same monolithic semiconductor die, the local oscillator sources may be consolidated, thereby reducing the complexity and power consumption of the satellite radio receiver system, as well as decreasing the die area in which the receiver system is fabricated.

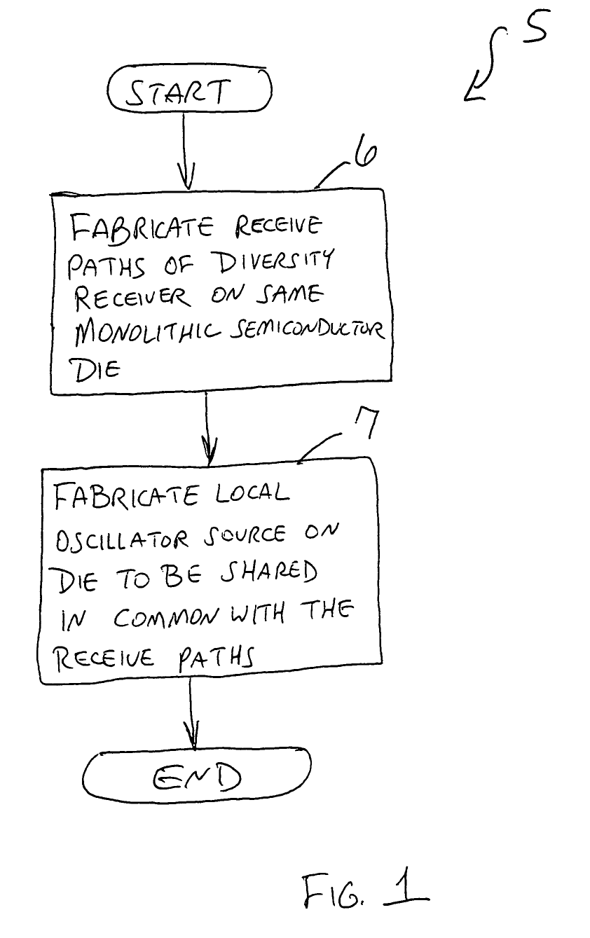

More specifically, referring to FIG. 1, a technique 5 in accordance with the invention includes fabricating the receive paths of a diversity receiver on the same monolithic semiconductor die, as depicted in block 6. A local oscillator source is also fabricated (block 7) on the die and is shared in common with the receive paths.

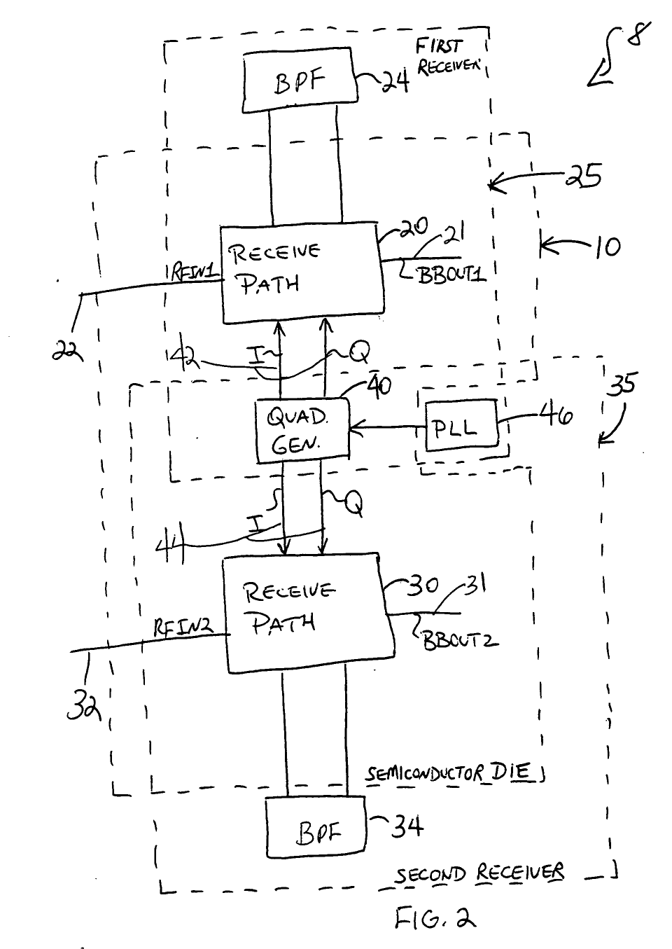

Referring to FIG. 2, as a more specific example, in accordance with some embodiments of the invention, a diversity receiver system 8 includes a monolithic semiconductor die 10 in which is fabricated two receive paths 20 and 30. The monolithic die 10 may be, for example, a die of a semiconductor package. The diversity receiver system 8 may be a satellite radio receiver system, in some embodiments of the invention.

Each receive path 20, 30 receives an RF signal from an associated antenna and translates the same selected RF channel of the RF signal to baseband. For example, as depicted in FIG. 1, the receive path 20 receives an incoming RF signal (called “RFIN1”) from an associated antenna (not shown) at an input terminal 22 and provides a corresponding analog baseband signal (called “BB_{OUT1}”) at its output terminal 21. Similarly, the receive path 30 receives an incoming RF signal (called “RFIN2”) from an associated antenna (not shown) at an input terminal 32 and provides a corresponding analog baseband signal (called “BB_{OUT2}”) at its output terminal 31. It is noted that in some embodiments of the invention, the output terminals 21 and 31 may be external terminals to the semiconductor die 10 and may be external terminals to the semiconductor package in which the die 10 is disposed.

In some embodiments of the invention, the baseband signal that is produced by the receive paths 20, 30 may be used (by a baseband processor, for example) to determine a carrier-to-noise (C/N) ratio for the receive path 20, 30. Thus, in some embodiments of the invention, a particular receive path 20, 30 is selected to generate the baseband signal for the receiver system 8 based on the C/N ratios.

In some embodiments of the invention, the receive path 20 forms part of a first receiver 25 (a first satellite radio receiver, for example); and the receive path 30 forms part of a second receiver 35 (a second satellite radio receiver, for example).

In accordance with embodiments of the invention, the receive paths 20 and 30 share a local oscillator source. For example, as depicted in FIG. 2, in some embodiments of the invention, the receive paths 20 and 30 share the same quadrature local oscillator source, a source that includes a quadrature generator 40 that receives a local oscillator signal from a phase locked loop (PLL) 46. In some embodiments of the invention, the quadrature generator 40 is fabricated on the die 10; and the PLL 46 is located off of the die (i.e., the PLL 46 is “off-chip”).

The quadrature generator 40 provides I and Q quadrature signals, i.e., cosine and sine signals, in some embodiments of the invention. As depicted in FIG. 2, in some embodiments of the invention, the quadrature generator 40 includes output terminals 42 that provide the I and Q signals to the receive path 20; and the quadrature generator 40 includes output terminals 44 that provide the I and Q signals to the receive path 30. In some embodiments of the invention, the terminals 42 and 44 may be connected together in parallel.

In some embodiments of the invention, each receive path 20, 30 uses the I and Q signals for purposes of driving an image reject mixer of the receive path 20, 30. Thus, each receive path 20, 30 may, for example, use the I and Q signals for purposes of translating a selected RF channel to an intermediate frequency (IF), in some embodiments of the invention. Furthermore, in other embodiments of the invention, each receive path 20, 30 may use the I and Q signals for purposes of translating an IF channel to a baseband frequency. Thus, many variations are possible, depending on the particular embodiment of the invention.

As depicted in FIG. 2, the receive path 20 may be coupled to a bandpass filter (BPF) 24, such as a surface acoustic wave (SAW) filter; and the receiver 30 may be coupled to a BPF 34, such as a SAW filter. Both of the BPFs 24 and 34 may be external to the semiconductor package that contains the semiconductor die 10, in some embodiments of the invention. Furthermore, the BPFs 24 and 34 may have substantially the same center frequency and bandwidth.

Thus, in some embodiments of the invention, the first receiver 25 includes the receive path 20, the quadrature generator 40, the PLL 46 and the BPF 24; and the second receiver 35 includes the receive path 30, the quadrature generator 40, the PLL 46 and the BPF 34. Therefore, the quadrature generator 40 and PLL 46 are shared in common between the first 25 and second 35 receivers.

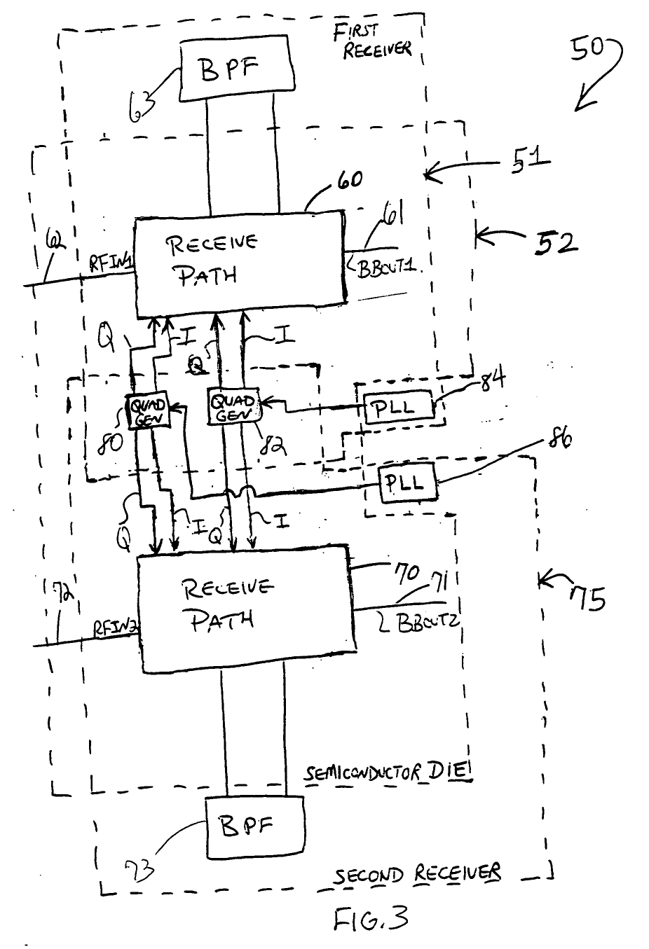

The receivers may share more than one set of I and Q quadrature signals, in other embodiments of the invention. For example, referring to FIG. 3, in another embodiment of the invention, a full diversity receiver system 50 in accordance with an embodiment of the invention may include a first receive path 60 and a second receive path 70 that are fabricated in a monolithic semiconductor die 52. The receive path 60 includes an input terminal 62 to receive an RF signal (called “RFIN1”) from an antenna 62; and the receive path 70 includes an input terminal 72 to receive an input signal (called “RFIN2”) from another antenna. In response to the RFIN1 and RFIN2 RF signals, the receive paths 60 and 70 generate baseband signals (called “BB_{OUT1}” and “BB_{OUT2},” respectively), similar to the receive paths 20 and 30 of the full diversity system 8 (see FIG. 2). As depicted in FIG. 3, the receive path 60 is coupled to a BPF 63 (an off-chip SAW filter, for example); and the receive path 70 is coupled to a BPF 73 (an off-chip SAW filter, for example).

As depicted in FIG. 3, the full diversity receiver system 50 includes two quadrature generators 80 and 82 that are fabricated on the die 52 with the receive paths 60 and 70. Each quadrature generator 80, 82 is shared by both receive paths 60 and 70. More specifically, the quadrature generator 80 may generate I and Q signals for purposes of demodulating the received RF signal; and the quadrature generator 82 may generate I and Q signals for purposes of demodulating the IF signal into the baseband signal. As shown in FIG. 2, the receive paths 60 and 70 share the quadrature generators 80 and 82. Thus, the receive paths 60 and 70 share the same local oscillator source.

As depicted in FIG. 3, in some embodiments of the invention, the quadrature generator 80 may be connected to receive a local oscillator signal from a phase locked loop (PLL) 84; and the quadrature generator 82 may be connected to receive a local oscillator signal from a PLL 86. In some embodiments of the invention, the PLLs 84 and 86 may be located off-chip and thus, the PLL 84 and 86 are not fabricated on the die 52. However, in some embodiments of the invention, one or more of the PLLs 84 and 86 may be fabricated on the die 52.

The receive path 60, the BFP 63, the quadrature generator 80, the quadrature generator 82 and the PLL 84 form a first receiver 51 (a satellite radio receiver, for example). The receive path 70, the BPF 73, the quadrature generator 80, the quadrature generator 82 and the PLL 86 form a second receiver 75. Thus, the quadrature generator 80 and 82 and the PLLs 84 and 86 are shared in common by the first 51 and second 75 receivers.

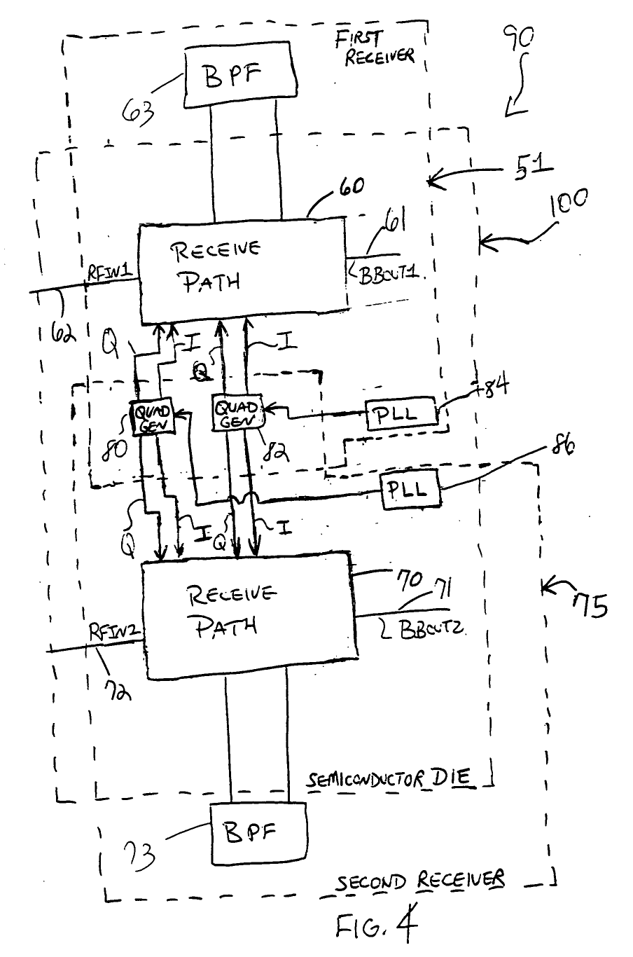

Referring to FIG. 4, in some embodiments of the invention, a satellite radio receiver system 90 may be used in place of the satellite radio receiver systems 8 and 50. The receiver system 90 has a similar design to the receiver system 50 with the following differences. In particular, a monolithic semiconductor die 100 replaces the monolithic semiconductor die 52. The semiconductor die 100 is similar in design to the semiconductor die 52, except that, unlike the semiconductor die 52, the PLLs 84 and 86 are fabricated on the semiconductor die 100.

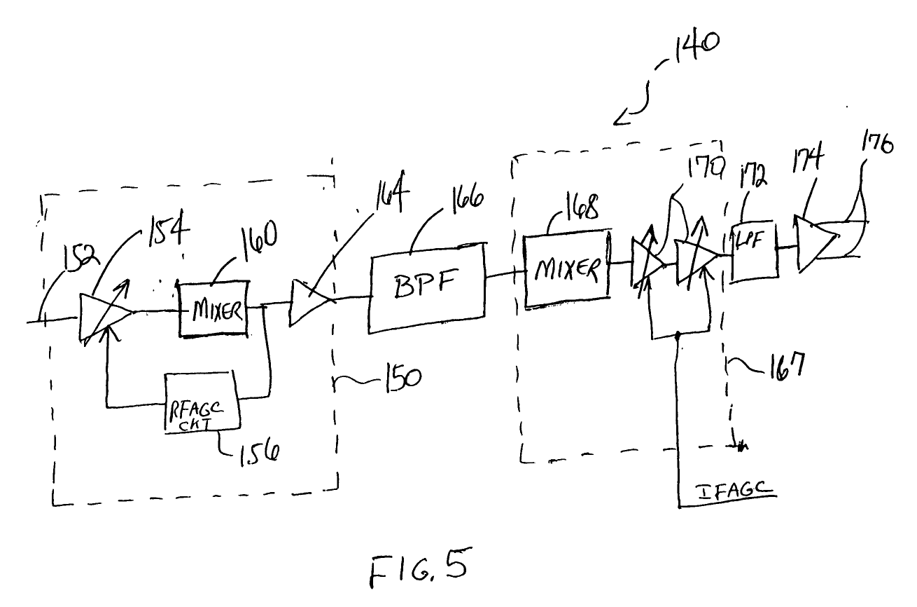

In some embodiments of the invention, each of the above-described receive paths may have an architecture 140 that is depicted in FIG. 5. The architecture 140 includes an RF section 150 and an IF section 167. The RF section 150 includes a variable gain low noise amplifier (LNA) 154 that has an input terminal 152 that receives an RF signal from an active antenna (not shown). The LNA 154 has a gain that is adjusted in response to a strength of the incoming RF signal, as determined by an RF Automated Gain Control (RFAGC) circuit 156.

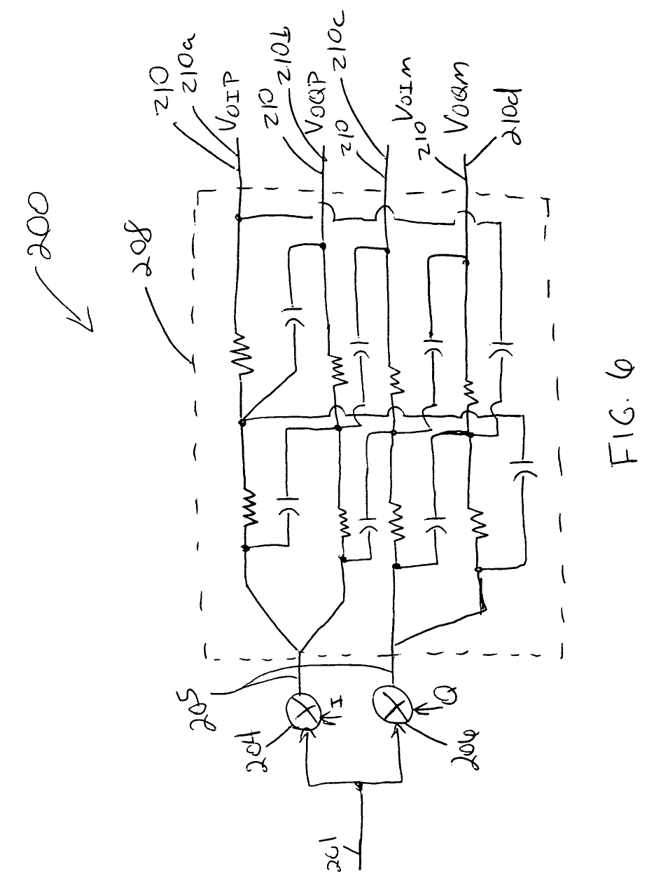

The output terminal of the LNA 154 provides an RF signal to an RF mixer 160 of the RF section 150. The RF mixer 160, in turn, translates a selected RF channel to a predetermined IF to produce a resultant output signal that is furnished to an input terminal of another LNA 164. In some embodiments of the invention, the mixer 160 may be an image reject mixer, similar to the image reject mixer that is depicted in FIG. 6 and described below. In other embodiments of the invention, the RF mixer 160 may be a multiplier that multiplies the incoming RF signal by a local oscillator signal for purposes of translating the selected RF channel to the predetermined IF. Thus, many variations are possible and are within the scope of the appended claims.

As depicted in FIG. 5, in some embodiments of the invention, the RFAGC circuit 156 has an input terminal that is coupled to the output terminal of the mixer 160 for purposes of sensing the strength of the incoming RF signal. However, in other embodiments of the invention, the RFAGC 156 may sense the signal that is present on the output terminal of the LNA 154 for purposes of determining the strength of the incoming RF signal.

As depicted in FIG. 5, in some embodiments of the invention, the output terminal of the LNA 164 provides an output signal to a bandpass filter (BPF) 166 (representing the BPF 24, 34, 63 or 73) that is centered at the predetermined IF to furnish (as its output terminal) a signal whose center frequency is at the center frequency of the BPF 166 and whose spectral energy is centered around the desired passband of the BPF 166.

The output terminal of the BPF 166 provides an IF signal to the IF section 167 of the architecture 140. More specifically, an IF mixer 168 of the IF section 167 has an input terminal that receives the output signal from the BPF 166. The IF mixer 168 may be a multiplier or an image reject filter that is driven in response to quadrature I and Q signals, depending on the particular embodiment of the invention. Regardless of the particular form of the IF mixer 168, the IF mixer 168 translates the IF channel of the incoming signal to a predetermined baseband frequency. The IF mixer 168 provides an output signal that is received by an input terminal of the first of one or more series-connected LNAs 170.

The gains of the LNAs 170, in turn, are controlled by a signal called “IFAGC.” The IFAGC signal is furnished by a baseband processor (not depicted in FIG. 5) that regulates the gains of the LNAs 170 in response to the determined strength of the baseband signal that is provided by the architecture 140.

As depicted in FIG. 5, the output terminal of the last LNA 170 in the series-connection is provided to an input terminal of a lowpass filter (LPF) 172, in some embodiments of the invention. The output terminal of the LPF 172 is coupled to an input terminal of an amplifier 174 that provides an analog differential baseband output signal at its output terminals 176.

The architecture 140 that is depicted in FIG. 5 is one out of many possible architectures for the receivers that are described herein. Thus, the architecture 140 may differ in other embodiments of the invention.

As noted above, depending on the particular embodiment of the invention, one or both of the mixers 160 and 168 may be an image reject mixer(s). Thus, for the receiver system 8 that is depicted in FIG. 2, one of the mixers 160 and 168 may be an image reject mixer. Likewise, for the receiver systems 50 and 90 that are depicted in FIGS. 3 and 4, both of the mixers 160 and 168 may be image reject mixers.

FIG. 6 depicts an image reject mixer 200 in accordance with an embodiment of the invention. The image reject mixer 200 includes an input terminal 201 that receives an input signal (to be mixed) that is communicated to the input terminals (shared in common) of multipliers 204 and 206. The multiplier 204 multiplies the input signal with the I quadrature signal; and the multiplier 206 multiplies the input signal with the Q quadrature local oscillator signal. The output terminals of the multipliers 204 and 206 are coupled to a two-stage polyphase filter 208 that filters the signals that are provided by the multipliers 204 and 206 to reject the image that is inherently produced by the translation.

The polyphase filter 208 has output terminals 210: an output terminal 210a providing a signal called “VIOP,” an output terminal 210b providing a signal called “VOQP,” an output terminal 210c providing a signal called “VOIM,” and an output terminal 210d providing a signal called “VOQM”. The VOIP, VOQP, VOIM and VOQM signals indicate the translated channel and the corresponding image. Two of the output terminals 210 may therefore be selected to provide the translated channel without the corresponding image. For example, in some embodiments of the invention, the output terminals 210a and 210c may be selected for purposes of providing a differential signal that indicates the translated channel.

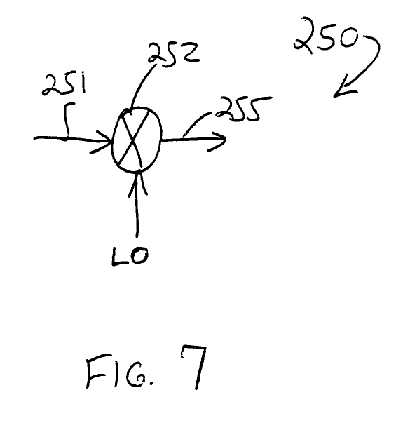

In some embodiments of the invention, one or possibly both of the mixers 160 and 168 (see FIG. 5) may be a mixer 250 that is depicted in FIG. 7. The mixer 250 includes a multiplier 252 that has an input terminal 251 that receives an input signal. The multiplier 252 multiplies the input signal with a local oscillator signal (called “LO” in FIG. 7) to translate a selected channel of the input signal to a different frequency. A signal that represents the product of this multiplication is provided on an output terminal 255 of the multiplier 252.

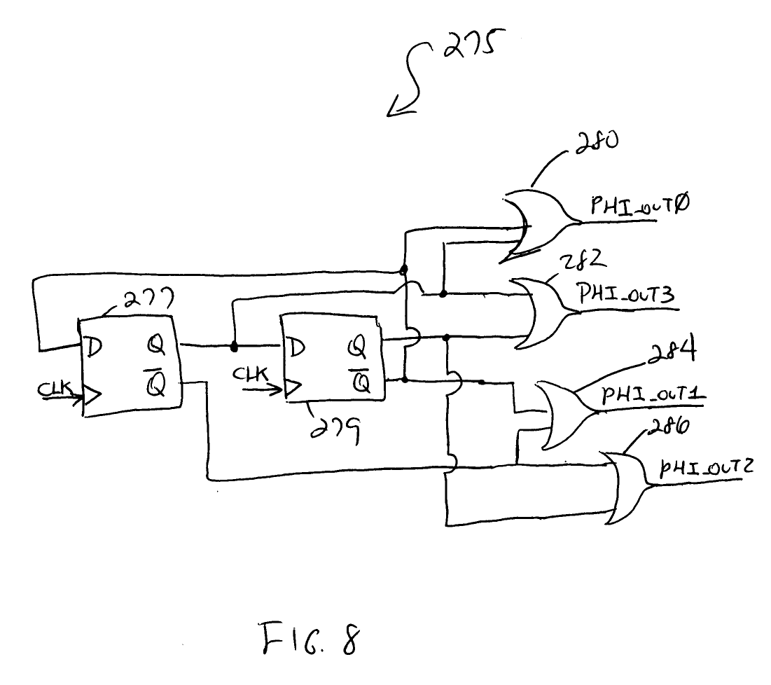

One or more of the above-described multipliers and/or mixers may be digital multipliers and/or mixers in some embodiments of the invention. For these embodiments of the invention, the multiplier(s)/mixer(s) may receive digital quadrature signals from a digital quadrature generator 275 that is depicted in FIG. 8. Thus, one or more of the quadrature generators 40 (FIG. 2), 80 (FIGS. 3 and 4) or 82 (FIGS. 3 and 4) may be digital quadrature generators, in some embodiments of the invention.

Referring to FIG. 8, the quadrature generator 275 includes D-type flip-flops 277 and 279 and OR gates 280 (providing an output signal called “PHI_OUT 0”), 282 (providing an output signal called “PHI_OUT 3”), 284 (providing an output signal called “PHI_OUT 1”), and 286 (providing an output signal called “PHI_OUT 2”). Each of the flip-flops 277 and 279 are clocked by a reference clock signal (called “CLK”).

One input terminal of the OR gate 280 is coupled to the signal input terminal of the flip-flop 277, and another input terminal of the OR gate 280 is coupled to the non-inverting output terminal of the flip-flop 277. One input terminal of the OR gate 282 is coupled to the non-inverting output terminal of the flip-flop 277, and another input terminal of the OR gate 282 is coupled to the non-inverting output terminal of the flip-flop 279. One input terminal of the OR gate 284 is coupled to the inverting output terminal of the flip-flop 279, and another input terminal of the OR gate 284 is coupled to the inverting output terminal of the flip-flop 277. One input terminal of the OR gate 286 is coupled to the inverting output terminal of the flip-flop 277, and another input terminal of the OR gate 286 is coupled to the non-inverting output terminal of the flip-flop 279.

The PHI_OUT 0, PHI_OUT 1, PHI_OUT 2 and PHI_OUT 3 signals are clock signals that have the same frequency as the CLK reference clock signal. However, each of these clock signals has a phase that is offset by 90 degrees from another one of the clock signals. Thus, as a more specific example, the PHI_OUT 1 clock signal may lag the PHI_OUT 0 signal by 90 degrees; the PHI_OUT 2 clock signal may lag the PHI_OUT 1 clock signal by 90 degrees; and the PHI_OUT 3 clock signal may lag the PHI_OUT 2 signal by 90 degrees. Therefore, as an example, the PHI_OUT 1 and PHI_OUT 3 signals (that are 180 degrees out of phase with respect to each other) may be selected to provide a differential clock signal indicative of the I quadrature signal; and the PHI_OUT 0 and PHI_OUT 2 signals (that are also separated in phase by 180 degrees) may be selected to provide a differential Q quadrature signal. Other variations are possible, in other embodiments of the invention.

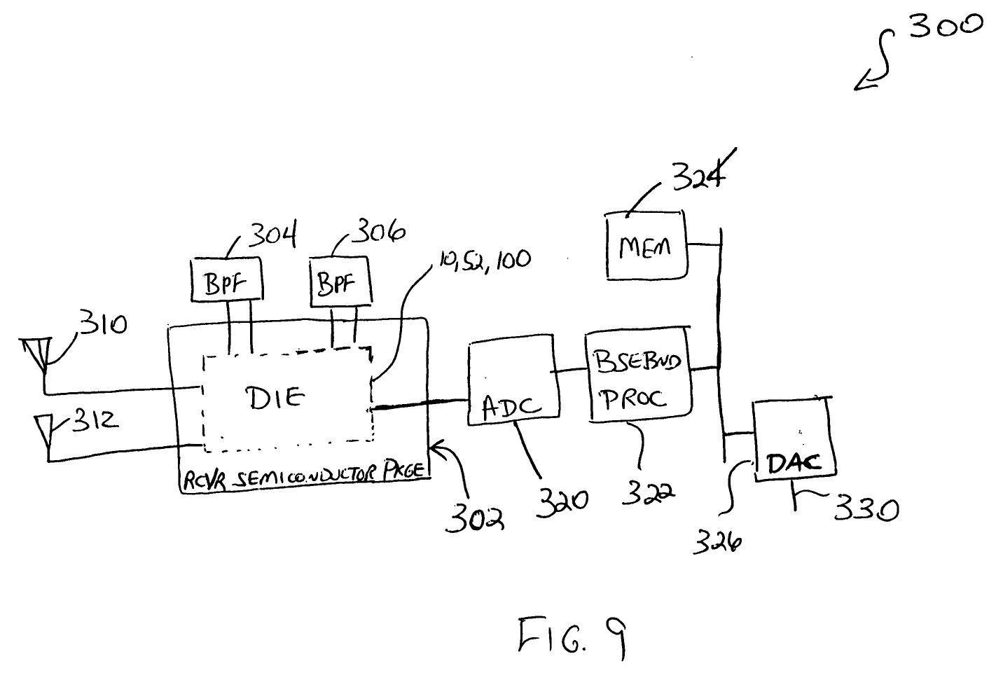

Referring to FIG. 9, in some embodiments of the invention, a satellite radio receiver system 300 may include a receiver semiconductor package 302 that converts received RF signals (received from active antennas 310 and 312) into corresponding baseband signals. Thus, in some embodiments of the invention, the receiver semiconductor package 302 may contain one of the dies 10, 52 and 100 that are discussed above. The die 10, 52 and 100 may be coupled to BPFs 304 and 306 (surface acoustic wave (SAW) filters, for example,) that are external to the semiconductor package 302. The satellite receiver system 300 includes an analog-to-digital converter (ADC) 320 that converts the analog baseband signal from the semiconductor package 302 into a digital signal that is received by a baseband processor 322. The baseband processor 322 demodulates the digital baseband signal to extract the satellite radio content data. This data may be temporarily stored in a memory 324, for example, of the satellite radio receiver system 300. Furthermore, the satellite radio receiver system 300 may include a digital-to-analog converter (DAC) 326 that converts the satellite radio data into an analog audio signal that may be used as a source signal to, for example, drive a speaker. In accordance with the embodiments described above, PLLs may be fabricated on or off of the semiconductor die.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A system comprising:
a monolithic semiconductor die;
receive paths fabricated on the die; and
a local oscillator source fabricated in the die and shared by the receive paths.

2. The system of claim 1, wherein the receive paths are substantially identical.

3. The system of claim 1, wherein each of the receive paths comprise at least one mixer.

4. The system of claim 3, wherein said at least one mixer comprises at least one of a radio frequency mixer and an intermediate frequency mixer.

5. The system of claim 1, wherein the local oscillator source comprises a quadrature generator.

6. The system of claim 1, further comprising:
bandpass filters, each bandpass filter being coupled to one of the receive paths and being external to the die.

7. The system of claim 6, wherein the bandpass filters comprise surface acoustic wave filters of substantially equal center frequency and bandwidth.

8. The system of claim 1, further comprising:
a phase locked loop fabricated on the die.

9. The system of claim 1, further comprising:
a phase locked loop that is located off of the die.

10. The system of claim 1, wherein the local oscillator source comprises a quadrature generator shared in common by the receive paths.

11. The system of claim 1, wherein each receive path translates a satellite radio signal to the baseband.

12. A system comprising:
a monolithic semiconductor die;
a first receive path fabricated on the die;
a second receive path fabricated on the die;
a first quadrature generator fabricated on the die and shared by the first receive path and the second receive path; and
a second quadrature generator fabricated on the die and shared by the first receive path and the second receive path.

13. The system of claim 12, wherein the receive paths are substantially identical.

14. The system of claim 12, wherein each of the receive paths comprise at least one mixer.

15. The system of claim 12, wherein said at least one mixer comprises at least one of a radio frequency mixer and an intermediate frequency mixer.

16. The system of claim 12, further comprising:
bandpass filters coupled to the receive paths and located off of the die.

17. The system of claim 16, wherein the bandpass filters comprise surface acoustic wave filters of substantially equal center frequency and bandwidth.

18. The system of claim 12, further comprising:
at least one phase locked loop fabricated on the die and adapted to provide a signal to at least one of the first and second quadrature generators.

19. The system of claim 12, further comprising:
at least one phase locked loop located off of the die and adapted to provide a signal to at least one of the first and second quadrature generators.

21. The system of claim 12, wherein each receive path translates a satellite radio signal to baseband.

22. A method comprising:
fabricating receive paths on a monolithic semiconductor die; and
fabricating a local oscillator source shared by the receive paths on the die.

23. The method of claim 22, wherein the receive paths are substantially identical.

24. The method of claim 22, wherein the local oscillator source comprises a quadrature generator.

25. The method of claim 22, wherein each of the receive paths comprise at least one mixer.

26. The method of claim 22, wherein said at least one mixer comprises at least one of a radio frequency mixer and an intermediate frequency mixer.

27. A method comprising:
fabricating a first receive path on a monolithic semiconductor die;
fabricating a second receive path on the die;
fabricating a first quadrature generator on the die, the first quadrature generator being adapted to be shared by the first receive path and the second receive path; and
fabricating a second quadrature generator on the die, the second quadrature generator being adapted to be shared by the first receive path and the second receive path.

28. The method of claim 27, wherein the receive paths are substantially identical.

29. The method of claim 27, wherein the local oscillator source comprises a quadrature generator.
